(19) United States
(12) Patent Application Publication
(10) Pub. No.: US 2022/0183465 A1
(43) Pub. Date: Jun. 16, 2022

(54) RECLINING DEVICE, SEAT, PRODUCTION METHOD FOR RECLINING DEVICE, AND CONNECTION METHOD FOR RECLINING DEVICE

(71) Applicant: DELTA KOGYO CO., LTD., Aki-gun (JP)

(72) Inventors: Etsunori FUJITA, Higashihiroshima-shi (JP); Kiyonori UMEZAKI, Aki-gun (JP); Kenta TSUCHIYA, Aki-gun (JP)

(73) Assignee: DELTA KOGYO CO., LTD., Aki-gun (JP)

(21) Appl. No.: 17/435,424

(22) PCT Filed: Jan. 15, 2020
(86) PCT No.: PCT/JP2020/001109

§ 371 Date: Sep. 1, 2021

(30) Foreign Application Priority Data
Mar. 2, 2019 (JP) 2019-038092

(51) Int. Cl. A47C 1/025; F16H 1/32; B23K 26/21

(52) U.S. Cl. CPC A47C 1/025; F16H 1/32; B23K 2101/008; F16H 2001/327; F16H 2001/323; B23K 26/21

(57) ABSTRACT

To increase strength without any weight increase due to a thickness increase and without causing the machining problem in half-blanking, an external gear and an internal gear are ring-shaped gears, and external teeth and internal teeth each have a tooth width substantially corresponding to the thickness of an outer circumferential surface of the external gear or an inner circumferential surface of the internal gear. The external gear and the internal gear are ring-shaped gears, that is, each can be formed through the punching of a plate, and strength resulting from the engagement of the external teeth and the internal teeth corresponds to strength resulting from the thickness of the material plates forming the external gear and the internal gear. Accordingly, the external teeth and the internal teeth can have a wider tooth width, achieving higher strength than when half-blanking is used.

### TECHNICAL FIELD

The present invention relates to a reclining device attached to a seat of a vehicle or the like to adjust an angle of inclination of a seat back relative to a seat cushion, in particular, to a Taumel-type reclining device, a seat including such a reclining device, a production method for such a reclining device, and a method for connecting such a reclining device to a seat cushion frame.

### BACKGROUND ART

Patent Documents 1 and 2 disclose a Taumel-type reclining device in which an external gear and an internal gear having a larger number of teeth than the external gear are combined with their axial centers set eccentric from each other, and which adjusts the amount of eccentricity using wedge-shaped member, thereby controlling the engagement of the external teeth and the internal teeth to be deeper to produce a locked state and shallower to produce an unlocked state.

### PRIOR ART DOCUMENT

### Patent Document

Patent Document 1: Japanese Patent Application Laid-open No. 2018-79827
Patent Document 2: Japanese Patent Application Laid-open No. 2010-22392

### DISCLOSURE OF THE INVENTION

### Problems to be Solved by the Invention

As is disclosed in Patent Documents 1 and 2, the external gear and the internal gear are both formed through half-blanking of a plate using a press, but strength against the forward and backward movement of a seat back depends on an engagement area when the external teeth and the internal teeth are engaged. In the case of the half-blanking, the external teeth and the internal teeth each have a tooth width of, at most, about 60 to 70% of the thickness of the material plate. To increase the engagement area, it is necessary to increase the plate thickness or increase the height of the half-blanking by a forging press. However, the increase in the plate thickness leads to a weight increase of the gears, and there is a limit in increasing the half-blanking height as described above. Further, the half-blanking has a machining problem of sagging occurring at both ends in terms of the half-blanking direction, which also affects the strength.

Further, to prevent the external gear and the internal gear from coming off in their axial direction (a BL direction of a seat when they are attached to the seat), a ring member (“a connecting ring 91” in Patent Document 1, “a ring-shaped holding member 70” in Patent Document 2) is fixed to an axial-direction one end after the external gear and the internal gear are stacked. Specifically, this ring member has a ring-shaped circumferential surface and a ring-shaped end surface projecting toward the inner side of the ring-shaped circumferential surface and thus has an L-shaped section, and for example, the ring-shaped circumferential surface is welded to an outer circumferential surface of a flange portion projecting outward at a portion, in the external gear, that is not a thickness range where the external teeth are formed, and between the ring-shaped end surface and the external gear, the internal gear is rotatably disposed, or conversely, the ring-shaped circumferential surface is welded to an outer circumferential surface of a flange portion of the internal gear and the external gear is disposed between the ring-shaped end surface and the internal gear. Therefore, the ring-shaped end surface serving as a stopper in the axial direction (the BL direction of the seat) is in contact only with an outer end surface of the internal gear or the external gear. However, in a Taumel-type reclining device, an external gear and an internal gear rotate relative to each other eccentrically.

Therefore, a peel load in such a direction as to make members such as the external gear and the internal gear come off in the axial direction (the BL direction of the seat) does not act evenly, and therefore, the ring member whose ring-shaped end surface is in contact only with the outer end surface of the external gear or the internal gear may lack strength against the peel load.

The present invention was made in consideration of the above, and has an object to provide a Taumel-type reclining device that can be increased in strength without being increased in weight by a thickness increase or without causing the above-described machining problem in half-blanking, a seat including such a reclining device, a production method for such a reclining device, and a method for connecting such a reclining device to a seat cushion frame.

### Means for Solving the Problems

To solve the above problem, the reclining device of the present invention is a reclining device including: one gear part connected to one of a seat cushion and a seat back; and the other gear part connected to the other of the seat cushion and the seat back,

wherein the one gear part includes an external gear,

wherein the other gear part includes an internal gear which has internal teeth engaged with external teeth of the external gear and larger in number than the external teeth, and

wherein axial centers of the external gear and the internal gear are set eccentric from each other,

the reclining device including a rotation control part which controls relative rotation of the external gear and the internal gear,

wherein the external gear and the internal gear are ring-shaped gears, and the external teeth and the internal teeth each have a tooth width substantially corresponding to a thickness of an outer circumferential surface of the external gear or an inner circumferential surface of the internal gear.

Preferably, the one gear part includes an external gear bracket higher in strength than the external gear and having a cylinder portion fixed to an inner circumferential surface of the external gear and a flange portion projecting outward from one end of the cylinder portion, and the cylinder portion is fixed to the inner circumferential surface of the external gear by welding.

Preferably, the cylinder portion and the inner circumferential surface of the external gear are welded all along a circumferential direction which is along a boundary between the cylinder portion and the inner circumferential surface, by laser light radiated in an axial direction.

Preferably, the flange portion of the external gear bracket has a size large enough to extend off an edge of an end surface of the external gear and cover at least part of an end surface of the internal gear.

Preferably, the other gear part includes an internal gear bracket higher in strength than the internal gear and having a bottom wall having a through hole at a center and an outer circumferential wall rising from an outer circumferential edge of the bottom wall and fixed to an outer circumferential surface of the internal gear, and

the outer circumferential wall is fixed to the outer circumferential surface of the internal gear by welding.

Preferably, the outer circumferential wall and the outer circumferential surface of the internal gear are welded all along the circumferential direction which is along a boundary between the outer circumferential wall and the outer circumferential surface, by laser light radiated in the axial direction.

Preferably, the internal gear bracket has an inner circumferential wall which rises from an inner circumferential edge of the bottom wall in a direction in which the outer circumferential wall rises, the inner circumferential wall being smaller in inside diameter than the cylinder portion of the external gear bracket.

Preferably, the external teeth of the external gear and the internal teeth of the internal gear are heat-treated.

A seat of the present invention is a seat which includes a seat cushion and a seat back, the seat including the aforesaid reclining device.

A production method for a reclining device of the present invention is a production method for a reclining device which includes: one gear part connected to one of a seat cushion and a seat back; and the other gear part connected to the other of the seat cushion and the seat back,

wherein the one gear part includes an external gear,

wherein the other gear part includes an internal gear which has internal teeth engaged with external teeth of the external gear and larger in number than the external teeth, and

wherein axial centers of the external gear and the internal gear are set eccentric from each other,

the reclining device including a rotation control part which controls relative rotation of the external gear and the internal gear, and the production method including:

forming, by punching, the external gear and the internal gear in a ring shape, with the external teeth and the internal teeth each having a tooth width substantially corresponding to a thickness of an outer circumferential surface of the external gear or an inner circumferential surface of the internal gear;

using an external gear bracket higher in strength than the external gear and having a cylinder portion and a flange portion projecting outward from the cylinder portion, and fixing an inner circumferential surface of the external gear to the cylinder portion by welding while aligning the axial center of the external gear with an axial center of the external gear bracket; and

using an internal gear bracket higher in strength than the external gear and having a bottom wall having a through hole at a center and an outer circumferential wall rising from an outer circumferential edge of the bottom wall to be fixed to an outer circumferential surface of the internal gear, and fixing the outer circumferential surface of the internal gear to the outer circumferential wall by welding while aligning the axial center of the internal gear with an axial center of the internal gear bracket.

Preferably, the production method includes:

radiating laser light in an axial direction to weld the cylinder portion and the inner circumferential surface of the external gear all along a circumferential direction which is along a boundary between the cylinder portion and the inner circumferential surface; and

radiating laser light in the axial direction to weld the outer circumferential wall and the outer circumferential surface of the internal gear all along the circumferential direction which is along a boundary between the outer circumferential wall and the outer circumferential surface.

A connection method for a reclining device of the present invention is a method for connecting a reclining device to a cushion bracket attached to a seat cushion frame, the connection method including:

using, as the cushion bracket, one having a ring-shaped projection projecting outward;

disposing the reclining device produced by the aforesaid production method for the reclining device with an axial-direction inner end surface of the external gear stacked on the ring-shaped projection; and

welding the axial-direction inner end surface of the external gear to the ring-shaped projection all along a circumferential direction of the ring-shaped projection, disposing the cylinder portion of the external gear bracket adjacently to a stepped portion of the ring-shaped projection, and performing welding on a boundary between the stepped portion and the cylinder portion all along the circumferential direction of the ring-shaped projection.

### Effect of the Invention

According to the present invention, the external gear and the internal gear which are assembled respectively in the one and other gear parts are both ring-shaped gears, and their external teeth and internal teeth each have a tooth width substantially corresponding to the thickness of the outer circumferential surface of the external gear or the inner circumferential surface of the internal gear. The external gear and the internal gear are each ring-shaped gears, that is, each can be formed through the punching of a material plate, and strength resulting from the engagement of the external teeth and the internal teeth corresponds to strength resulting from the thickness of the material plates forming the external gear and the internal gear. Accordingly, as compared with the use of half-blanking, the external teeth and the internal teeth each can have a wider tooth width, achieving higher strength, if the thickness of the material plate is the same, and if the tooth width is the same, a thinner plate can be used as the material plate, contributing to a reduction in material cost. Further, as compared with half-blanking, sagging occurs at fewer places, leading to workability improvement and strength improvement.

Further, the external gear bracket having the cylinder portion fixed to the inner circumferential surface of the external gear disposed on the inner side of the internal gear and the flange portion projecting outward from one end of the cylinder portion is used, and the flange portion covers the end surface of the external gear and at least part of the end surface of the internal gear, and accordingly, the flange portion of the external gear bracket is capable of restraining the axial-direction movement of the internal gear even if force in a peel direction (the BL direction of the seat) acts on the internal gear bracket fixed to the internal gear, leading to an increase in peed strength.

Further, since the external gear is integrated with the external gear bracket higher in strength than the external gear by welding, and the internal gear is integrated with the internal gear bracket higher in strength than the external gear by welding, the axial centers of the external gear and the internal gear are aligned respectively with the axial centers of the external gear bracket and the internal gear bracket. That is, even if the external gear or the internal gear deforms at the time of the punching such that the lateral and vertical diameters slightly differ, the axial center of the external gear or the internal gear does not deviate from the axial center of the external gear bracket or the internal gear bracket which is formed as a separate body. Therefore, the machining accuracy of the external gear and the internal gear need not be very strict even though they are formed separately from the external gear bracket and the internal gear bracket, and thus they can be worked easily.

### BRIEF DESCRIPTION OF DRAWINGS

FIG. 1 is a perspective view illustrating the outer appearance of a reclining device according to one embodiment of the present invention attached to a cushion bracket.

FIG. 2 is an exploded perspective view of FIG. 1.

FIG. 3 is a view of FIG. 1 seen from an internal gear bracket side.

FIG. 4 is a view of FIG. 1 seen from the cushion bracket side.

FIG. 5 is a plan view of FIG. 3.

FIG. 6 is an end surface view taken along the A-A line in FIG. 3.

FIG. 7 is an end surface view taken along the B-B line in FIG. 3.

FIG. 8(a) is a view illustrating the structure of one gear part, and FIG. 8(b) is an end surface view taken along the E-E line in FIG. 8(a).

FIG. 9(a) is a view illustrating a state in which the one gear part and the other gear part are combined, and FIG. 9(b) is an end surface view taken along the F-F line in FIG. 9(a).

FIG. 10(a) is a view illustrating the reclining device according to the embodiment attached to the cushion bracket, seen from the cushion bracket side, and FIG. 10(b) is an end surface view taken along the G-G line in FIG. 10(a).

FIG. 11(a) is a chart illustrating hardness distribution in a section along the radial direction of an external gear not having been heat-treated, FIG. 11(b) is a chart illustrating hardness distribution in one tooth-width-direction end surface of the external gear, and FIG. 11(c) is an enlarged chart of FIG. 11(b).

FIG. 12 illustrates micrographs of surface structure corresponding to the hardness distribution in the section along the radial direction of the external gear illustrated in FIG. 11(a).

FIG. 13(a) is a chart illustrating hardness distribution in a section along the radial direction of an external gear having undergone five-second heat treatment, FIG. 13(b) is a chart illustrating hardness distribution in one tooth-width-direction end surface of the external gear, and FIG. 13(c) is an enlarged chart of FIG. 13(b).

FIG. 14 illustrates micrographs of surface structure corresponding to the hardness distribution in the section along the radial direction of the external gear illustrated in FIG. 13(a).

FIG. 15(a) is a chart illustrating hardness distribution in a section along the radial direction of an external gear having undergone six-second heat treatment, FIG. 15(b) is a chart illustrating hardness distribution in one tooth-width-direction end surface of the external gear, and FIG. 15(c) is an enlarged chart of FIG. 15(b).

FIG. 16 illustrates micrographs of surface structure corresponding to the hardness distribution in the section along the radial direction of the external gear illustrated in FIG. 15(a).

FIG. 17(a) illustrates graphs of the measurement results of the hardness distributions in the radial direction, and FIG. 17(b) illustrates graphs of the measurement results of the hardness distributions in the thickness direction.

### DESCRIPTION OF EMBODIMENTS

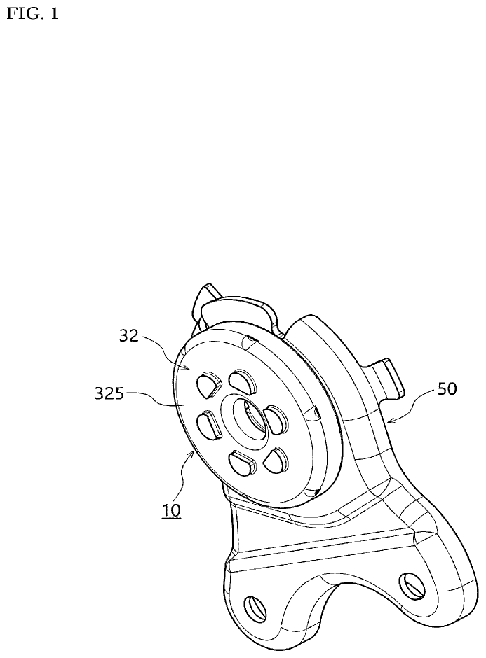

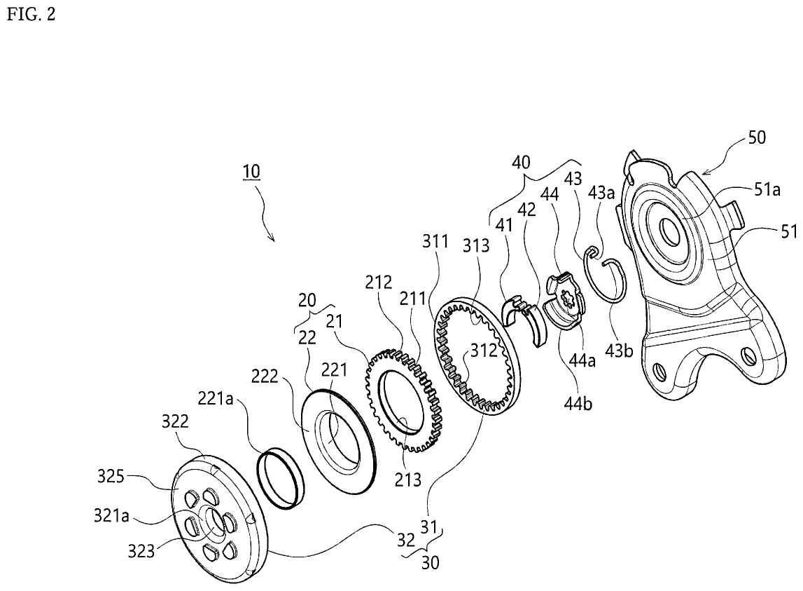

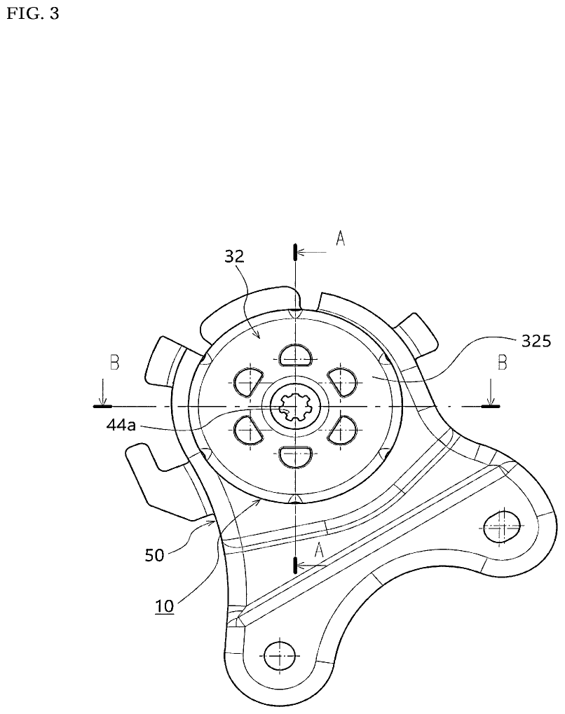

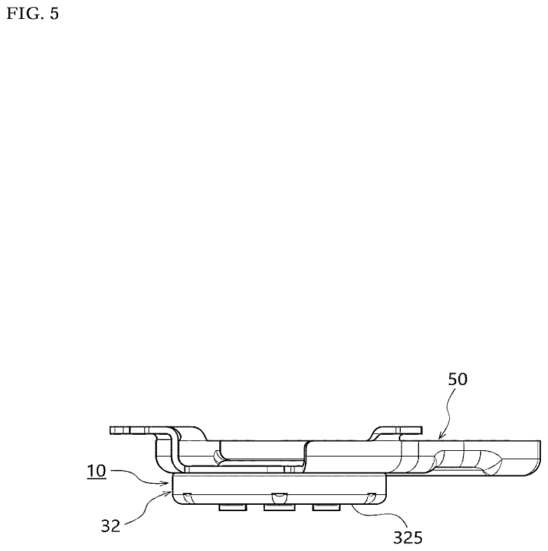

The present invention will be hereinafter described in more detail based on an embodiment illustrated in the drawings. FIG. 1 to FIG. 7 illustrate a reclining device 10 according to the embodiment of the present invention. The reclining device 10 is attached between a side frame (not illustrated) of a seat cushion frame and a side frame (not illustrated) of a seat back frame. As illustrated in FIG. 1 to FIG. 7, the reclining device 10 is a Taumel-type mechanism including one gear part 20 and the other gear part 30, one of which includes an external gear 21 and the other of which includes an internal gear 31. In this embodiment, the external gear 21 is provided in the gear part 20 and the internal gear 31 is provided in the other gear part 30.

The gear part 20 includes the external gear 21 and an external gear bracket 22. The external gear 21 is a ring-shaped gear and has external teeth 212 formed on its outer circumferential surface 211. The ring-shaped gear constituting the external gear 21, including the external teeth 212, is formed through the punching of a material plate with a predetermined thickness. Therefore, the thickness of the material plate is the thickness of the outer circumferential surface 211, and the tooth width of the external teeth 212 formed by the punching is equal to the thickness of the outer circumferential surface 211.

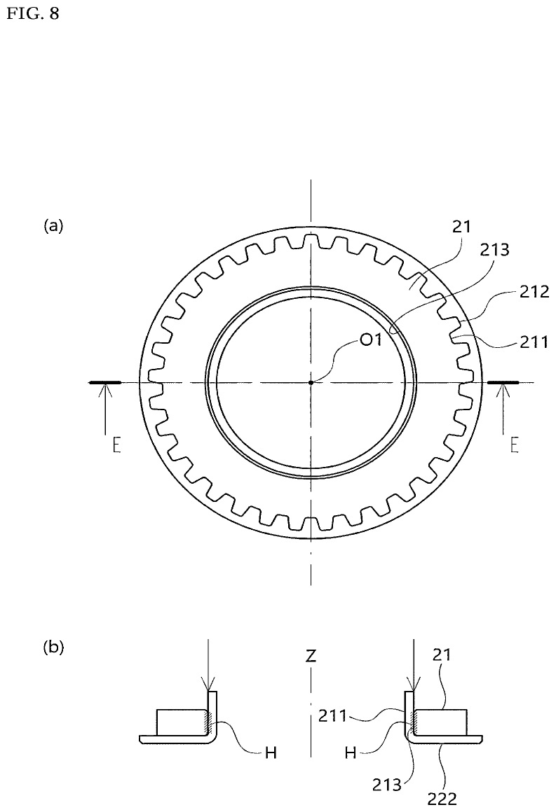

The external gear bracket 22 has a cylinder portion 221 and a flange portion 222. The outside diameter of the cylinder portion 221 is substantially equal to the inside diameter of an inner circumferential surface 213 of the external gear 21, and the cylinder portion 221 is insertable to the inner side of the inner circumferential surface 213. The cylinder portion 221 is fixed to the inner circumferential surface 213 by laser welding or the like while inserted to the inner side of the inner circumferential surface 213. At the time of the welding of the cylinder portion 221 to the external gear 21, it is preferable to radiate laser light to a boundary (the hatched portion denoted by reference sign H in FIG. 8(b)) between the cylinder portion 221 and the inner circumferential surface 213 of the external gear 21 from a point substantially on an extension of the boundary, that is, in the illustrated arrow direction which is an axial direction (Z-direction) of the reclining device 10, as illustrated in FIGS. 8(a), (b) to perform the welding all along the circumferential direction along the boundary. Consequently, facing surfaces of the cylinder portion 221 of the external gear bracket 22 and the inner circumferential surface 213 of the external gear 21 are welded along the circumference, achieving high welding strength in the rotation direction.

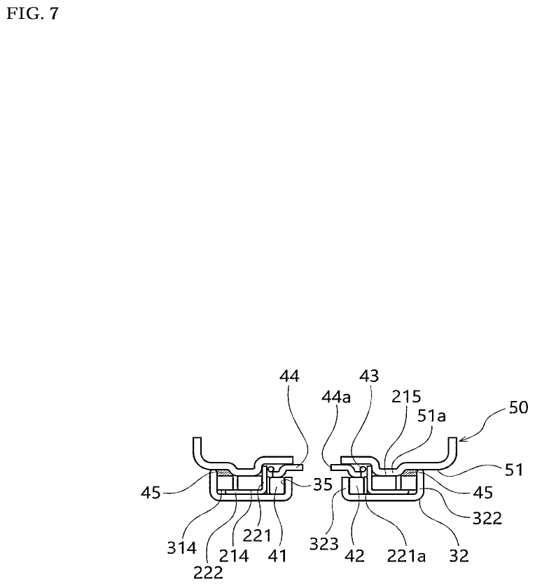

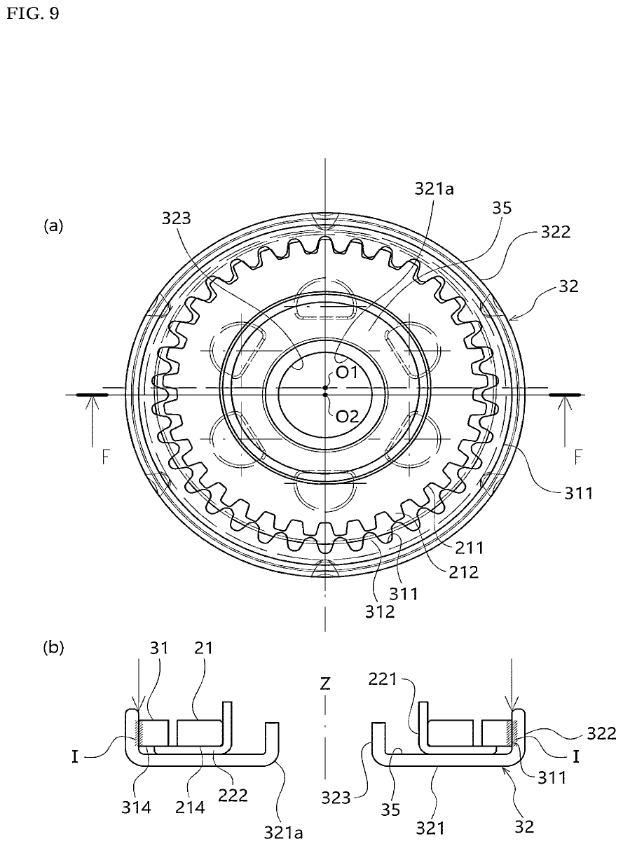

The flange portion 222 is substantially ring-shaped and projects from one end of the cylinder portion 221 in an outward direction substantially orthogonal to the axial direction of the cylinder portion 221. The external gear bracket 22 is attached with the cylinder portion 221 inserted along the inner circumferential surface 213 of the external gear 21 and fixed to the inner circumferential surface 213 and with the flange portion 222 stacked in close contact on one end surface 214 of the external gear 21. The flange portion 222 has an area large enough to extend beyond the range of the end surface 214 of the external gear 21 and can cover one end surface 314, of the later-described internal gear 31, at least part of which is located on a radially outer side of the external gear 21 (see FIG. 7 and FIG. 9(b)).

The other gear part 30 includes the internal gear 31 and an internal gear bracket 32. The internal gear 31 is a ring-shaped gear and has internal teeth 312 formed on its inner circumferential surface 313. The internal gear 31, including the internal teeth 312, is also formed through the punching of a plate with a predetermined thickness similarly to the external gear 21. Therefore, the tooth width of the internal teeth 312 is equal to the thickness of the inner circumferential surface 313.

The inner circumferential surface 313 of the internal gear 31 has an inside diameter large enough for the external gear 21 to be inserted to the internal gear 31, and the external teeth 212 of the inserted external gear 21 are engageable with the internal teeth 312. Further, the number of the internal teeth 312 is larger than the number of the external teeth 212. Accordingly, when the internal gear 31 and the external gear 21 relatively rotate while the external teeth 212 and the internal teeth 312 are engaged with each other, an axial center O1 of the external gear 21 is eccentric from an axial center O2 of the internal gear 31 (see FIG. 9(a)). That is, the external gear 21 moves in the inner side of the inner circumferential surface 313 of the internal gear 31 while relatively rotating around the axial center O1 eccentric from the axial center O2 of the internal gear 31.

As illustrated in FIG. 7 and FIGS. 9(a), (b), the internal gear bracket 32 has a bottom wall 321, an outer circumferential wall 322, and an inner circumferential wall 323. The bottom wall 321 has a through hole 321a at its center. The outer circumferential wall 322 has a substantially cylindrical shape rising from an outer circumferential edge of the bottom wall 321 in the axial direction by a predetermined height. The inner circumferential wall 323 has a substantially cylindrical shape rising from an inner circumferential edge, of the bottom wall 321, forming the through hole 321a in the axial direction by a predetermined height similarly to the outer circumferential wall 322. The inside diameter of the outer circumferential wall 322 is substantially equal to the outside diameter of the internal gear 31, and the outer circumferential wall 322 is stacked on the outer circumferential surface 311 of the internal gear 31 and they are fixed by laser welding or the like. The through hole 321a and the inner circumferential wall 323 are smaller in inside diameter than the cylinder portion 221 of the external gear bracket 22, and accordingly, when the outer circumferential wall 322 of the internal gear bracket 32 is fixed to the outer circumferential surface 311 of the internal gear 31 while the internal gear 31 is disposed around an outer periphery of the external gear 21 to which the external gear bracket 22 is fixed, a placement space 35 where to place later-described wedge-shaped members 41, 42 is formed between the inner circumferential wall 323 and the cylinder portion 221.

In welding the outer circumferential wall 322 to the outer circumferential surface 311 of the internal gear 31, the welding may be performed from the outer surface of the outer circumferential wall 322 in the radial direction, but as illustrated in FIG. 9(b), it is preferable to radiate laser light to a boundary (the hatched part denoted by the reference sign I in FIG. 9(b)) between the outer circumferential wall 322 and the outer circumferential surface 311 of the internal gear 31 from a point substantially on an extension of the boundary, that is, in the illustrated arrow direction which is the axial direction (Z-direction) of the reclining device 10, and weld the outer circumferential wall 322 all along the circumferential direction along the boundary. Consequently, facing ranges of the outer circumferential wall 322 and the outer circumferential surface 311 of the internal gear 31 are fixed to each other, achieving high welding strength in the rotation direction.

The reclining device 10 of this embodiment further includes a rotation control part 40. The rotation control part 40 includes the wedge-shaped members 41, 42, a spring 43, a rotation operation member 44, and so on. The wedge-shaped members 41, 42 are placed in the placement space 35 formed between the inner circumferential wall 323 of the internal gear bracket 32 and the cylinder portion 221 of the external gear bracket 22 as described above, and a ring-shaped bush 221a is stacked on the inner circumferential surface of the cylinder portion 221, and the wedge-shaped members 41, 42 are placed on the inner side of the bush 221a.

The wedge-shaped members 41, 42 are a pair of arc-shaped members. In each of the wedge-shaped members 41, 42, the thickness of its circumferential-direction one end (corresponding to its length along the radial direction of the external gear 21 and the internal gear 31) is large and the thickness of its other end is small.

The spring 43 is substantially ring-shaped and has end portions 43a, 43b bent in one direction. The spring 43 is disposed with its end portions 43a, 43b hooked to the one ends of the wedge-shaped members 41, 42, to bias the wedge-shaped members 41, 42 in such a direction as to separate the wedge-shaped members 41, 42 in the circumferential direction. In the placement space 35, the wedge-shaped members 41, 42 biased by the spring 43 try to penetrate in such a direction as to reduce the gap between the cylinder portion 221 of the external gear bracket 22 and the inner circumferential wall 323 of the internal gear bracket 32. That is, the wedge-shaped members 41, 42 are biased in such a direction as to increase the amount of eccentricity of the axial center O1 of the external gear 21 and the axial center O2 of the internal gear 31, thereby acting to more deepen the engagement between the external teeth 212 and the internal teeth 312. This does not allow the relative rotation of the external gear 21 and the internal gear 31 to maintain a locked state, that is, a state not allowing the seat back to recline.

The rotation operation member 44 is formed of a substantially ring-shaped plate member having a through hole 44a to which a not illustrated manual or electric rotary shaft is inserted. The rotation operation member 44 has an arc-shaped wall 44b rising in the axial direction from part of its circumferential edge and having a predetermined length in the circumferential direction. The arc-shaped wall 44b is located between the other ends of the pair of wedge-shaped members 41, 42 placed in the aforesaid placement space 35. The spring 43 is supported along an outer circumferential surface of the rotation operation member 44, and only its end portions 43a, 43b project into the placement space 35.

The rotation of the not-illustrated rotary shaft in either direction causes one of the wedge-shaped members 41, 42 to move against the elasticity of the spring 43 in such a direction as to increase the gap between the cylinder portion 221 of the external gear bracket 22 and the inner circumferential wall 323 of the internal gear bracket 32. This reduces the amount of eccentricity between the axial center O1 of the external gear 21 and the axial center O2 of the internal gear 31 to shallow the engagement between the external teeth 212 and the internal teeth 312. As a result, the locked state is released, enabling the relative rotation of the external gear 21 and the internal gear 31, and since the other of the wedge-shaped members 41, 42 moves in such a direction as to narrow the gap between the cylinder portion 221 and the inner circumferential wall 323 owing to the elasticity of the spring 43, the external gear 21 and the internal gear 31 relatively rotate while kept eccentric from each other, allowing the reclining of the seat back.

In the reclining device 10 of this embodiment, the gear part 20 including the external gear 21 and the external gear bracket 22 and the other gear part 30 including the internal gear 31 and the internal gear bracket 32 are assembled in the above-described manner. Then, the wedge-shaped members 41, 42 are placed in the placement space 35, and the spring 43 and the rotation operation member 44 are disposed between the wedge-shaped members 41, 42 and an attachment surface 51 of a cushion bracket 50 fixed to the seat cushion frame and are fixed to the cushion bracket 50. Consequently, the aforesaid members are housed between the internal gear bracket 32 which is located on the outermost side and the cushion bracket 50.

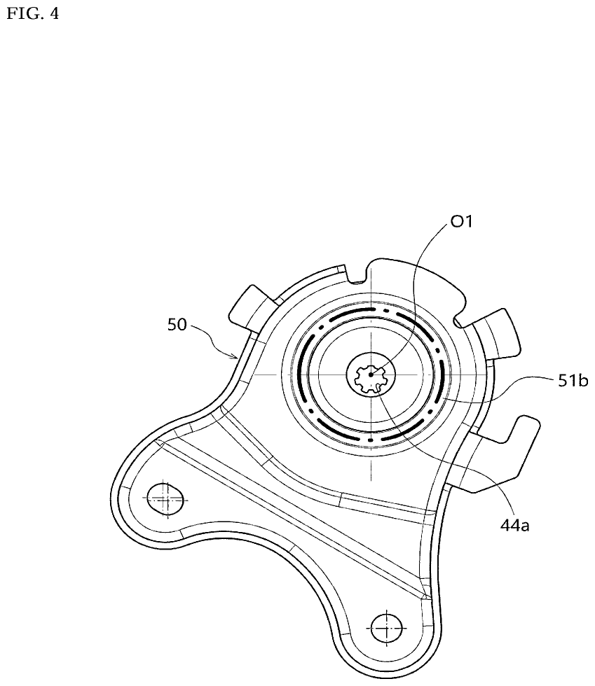

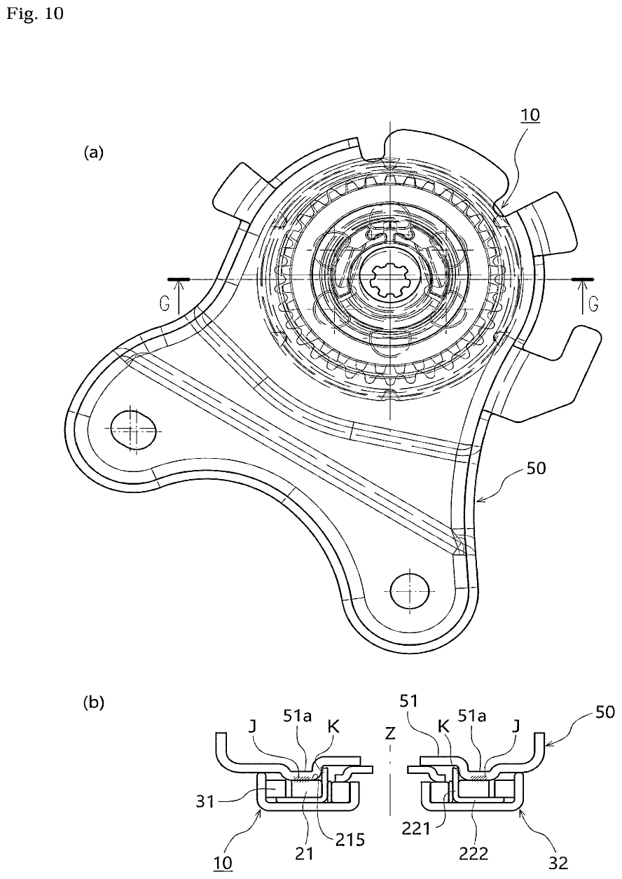

To fix the cushion bracket 50 and the reclining device 10, a welding means such as laser welding is usable. Specifically, on the attachment surface 51 of the cushion bracket 50, a ring-shaped projection 51a projecting in the direction of the external gear 21 is formed in a ring shape at a position corresponding to the external gear 21, and as illustrated in FIG. 10(b), the external gear 21 is stacked on the ring-shaped projection 51a, and a boundary (the hatched part denoted by the reference sign J in FIG. 10(b)) between facing surfaces of an axial-direction inner end surface 215 of the external gear 21 and the ring-shaped projection 51a are welded. As indicated by the one-dot chain line in FIG. 4, the welding is preferably performed all along the circumferential direction of the ring-shaped projection 51a and the external gear 21, which enables an increase in the welding strength against force in the rotation direction. Further, as illustrated in FIG. 7, FIG. 8(b), and FIG. 10(b), an axial-direction length of the cylinder portion 221 of the external gear bracket 22 is slightly longer than the thickness of the external gear 21. Therefore, it is preferable to dispose the cylinder portion 221 adjacently to a stepped portion between the attachment surface 51 and the ring-shaped projection 51a and also perform the welding on a boundary (the hatched part denoted by the reference sign K in FIG. 10(b)) between the stepped portion of the ring-shaped projection 51a and the cylinder portion 221 facing it, all along the circumferential direction. As a result, the gear part 20 in which the external gear 21 and the external gear bracket 22 are integrated is firmly fixed to the cushion bracket 50 in two directions of the rotation direction and the axial direction.

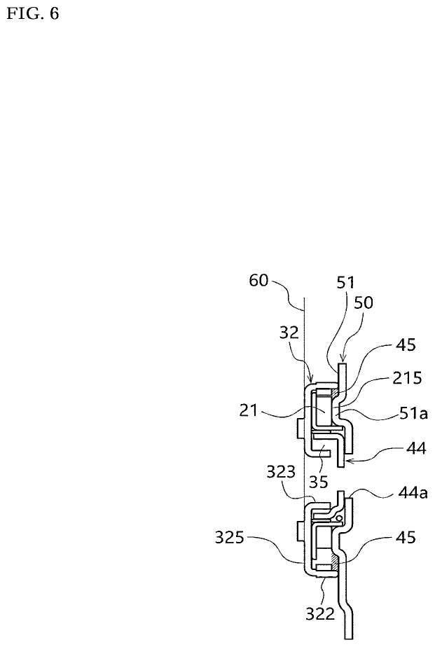

An axial-direction outer end surface 325 of the internal gear bracket 32 is fixed to a back-side bracket 60 of the seat back frame by laser welding or the like (see FIG. 6). Consequently, the seat back rotates together with the internal gear 31 and the internal gear bracket 32 relative to the external gear 21 and the external gear bracket 22 fixed to the seat cushion.

As illustrated in FIG. 6, FIG. 7, and FIG. 9, the outer circumferential wall 322 of the internal gear bracket 32 is formed such that its length along the axial direction (Z-direction) of the reclining device 10 exceeds the thickness of the internal gear 31 (its length along the axial direction (Z-direction) of the reclining device 10). When the external gear 21 is fixed onto the ring-shaped projection 51a of the attachment surface 51, a space 45 surrounded by the stepped portion of the ring-shaped projection 51a projecting from the attachment surface 51 and the outer circumferential wall 322 is formed. This space 45 functions as a grease pool where excess grease in the reclining device 10 pools to be capable of reducing the leakage of the excess grease to the outside of the reclining device 10.

According to this embodiment, the external gear 21 and the internal gear 31 are both ring-shaped gears. Therefore, they each can be produced through the punching of a material plate, and the external teeth 212 and the internal teeth 312 each have a tooth width substantially equal to the plate thickness of the material plate. Therefore, as compared with conventional gears produced by half-blanking, the tooth width is wider and the contact area is larger even if the plate thickness is the same, enabling increases in withstand load and strength. Further, sagging at the time of the machining occurs less than in the half-blanking, which also contributes to strength improvement. Further, since the external gear 21 and the internal gear 31 each have a thickness equal to the thickness of the material plate, withstand load and strength against a twisting moment in the seat BL direction which is the axial direction (Z-direction) also increases. In addition, the flange portion 222 of the external gear bracket 22 extends beyond the range of the end surface 214 of the external gear 21 and covers the end surface 314, of the internal gear 32, at least part of which is located on the radially outer side of the external gear 21. Therefore, against the force in the axially outward direction, that is, the peel direction, the flange portion 222 restricts the movement of the internal gear 31 in the same direction. This improves the strength in the peel direction, making it possible to inhibit the force acting in the rotation direction of the engaged external teeth 212 and internal teeth 312 from escaping.

Here, preferably, the external gear bracket 22 is formed of a material higher in strength than the material of the external gear 21, and the internal gear bracket 32 is formed of a material higher in strength than the material of the internal gear 31. In this embodiment, the external gear 21 is integrated with the external gear bracket 22 by welding and the internal gear 31 is integrated with the internal gear bracket 32 by welding. Therefore, the axial centers O1, O2 of the external gear 21 and the internal gear 31 are aligned respectively with the axial centers O1, O2 of the external gear bracket 22 and the internal gear bracket 32 higher in strength than the external gear 21 and the internal gear 31. Therefore, even if the external gear 21 or the internal gear 31 deforms at the time of the punching such that the vertical and lateral diameters slightly differ, assembling the external gear 21 or the internal gear 31 to the external gear bracket 22 or the internal gear bracket 32 formed as a separate body prevents deviation in the axial center O1 or O2 therebetween. In other words, the machining accuracy of the external gear 21 and the internal gear 31 need not be very strict in spite of that they are formed as separate bodies from the external gear bracket 22 and the internal gear bracket 32, which facilitates the machining. From the above, the external gear 21 and the internal gear 31 are preferably formed of high-tensile steel whose tensile strength is 490 MPa or more, and the external gear bracket 22 and the internal gear bracket 32 are preferably formed of ultrahigh-tensile steel whose tensile strength is 980 MPa or more.

It is also preferable to heat-treat tooth surfaces of the external teeth 212 and the internal teeth 312 to increase their hardness. The heat treatment is preferably induction heating. The induction heating is capable of partial heating of only the vicinity of the tooth surfaces of the external teeth 212 and the internal teeth 312 and thus does not impair weldability of parts of the external gear 21 and the internal gear 31 except the inductively-heated ranges. Further, at the time of the induction heating, it is possible to remove burrs caused by pressing.

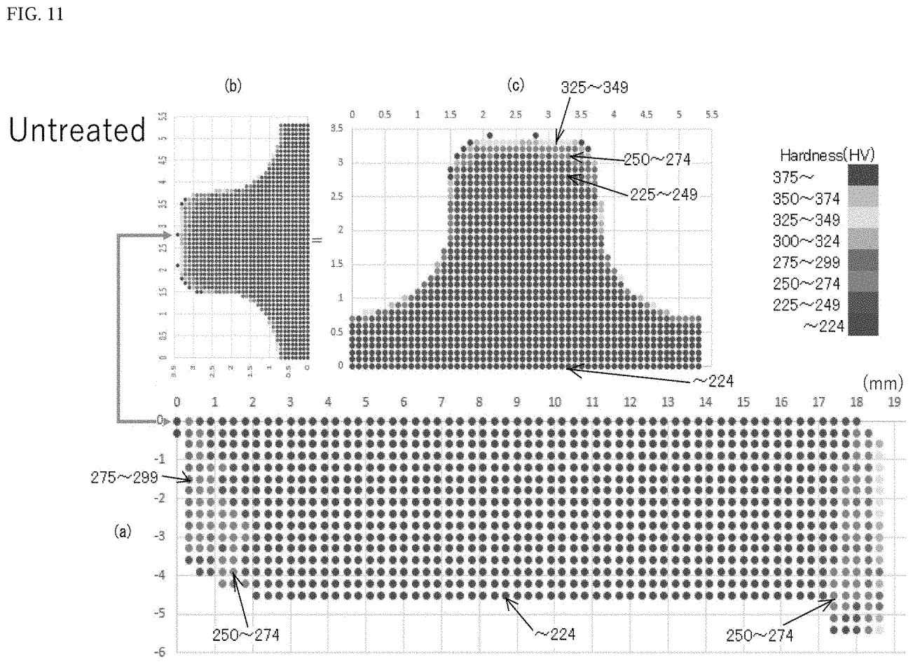

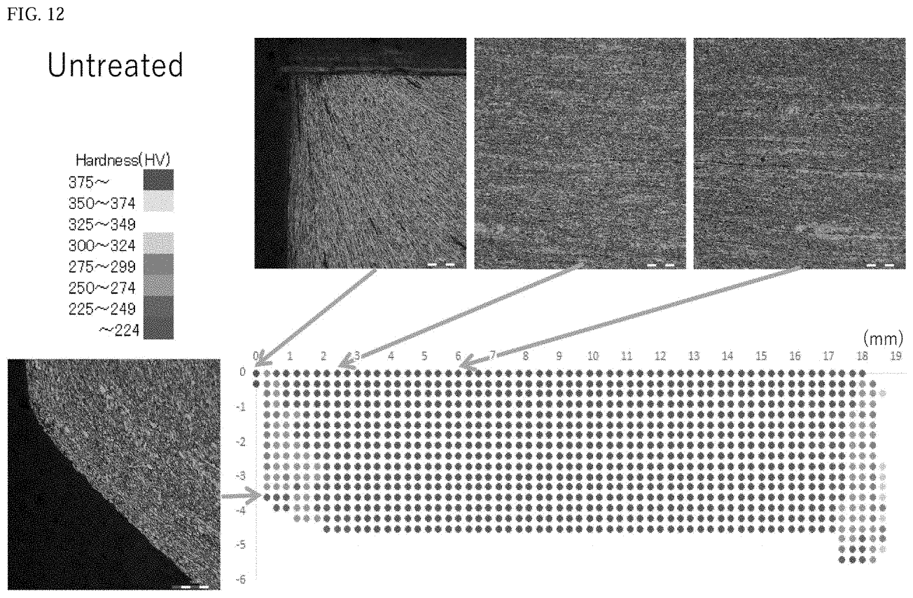

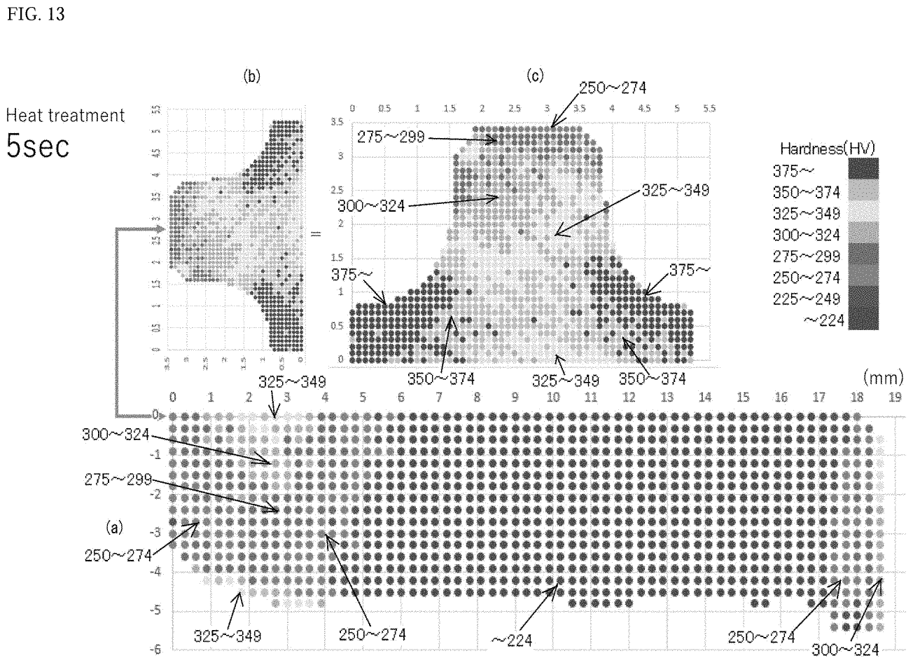

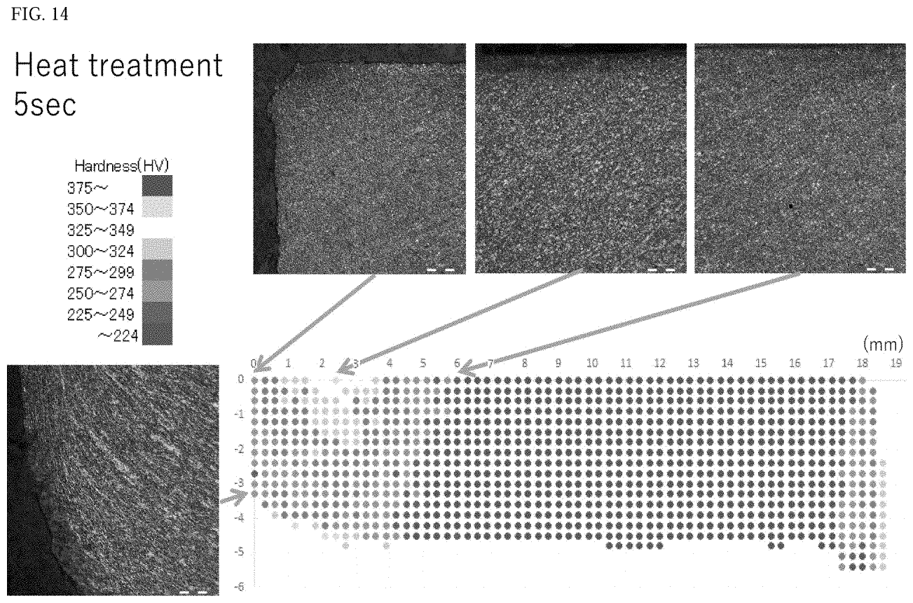

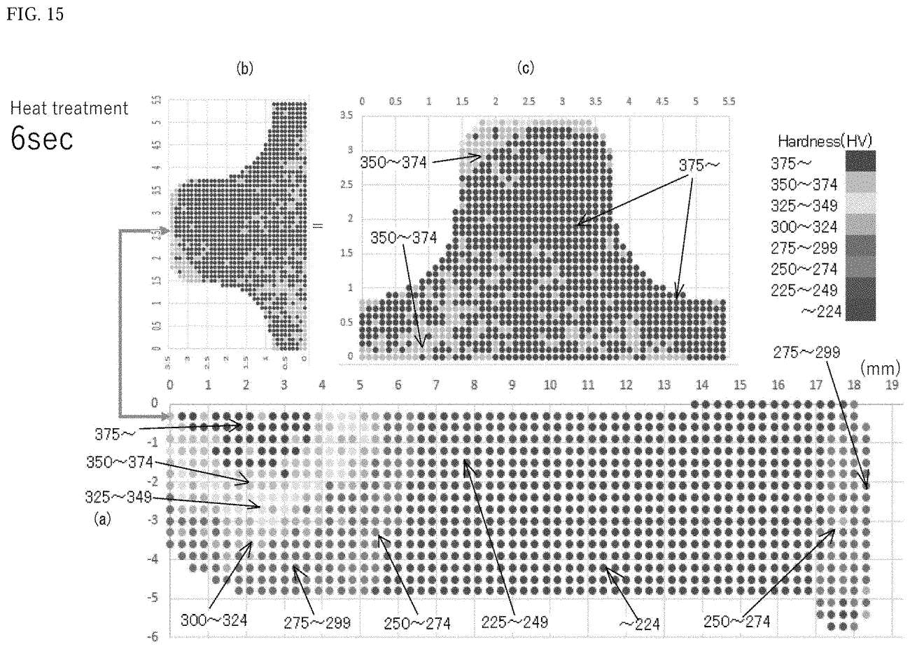

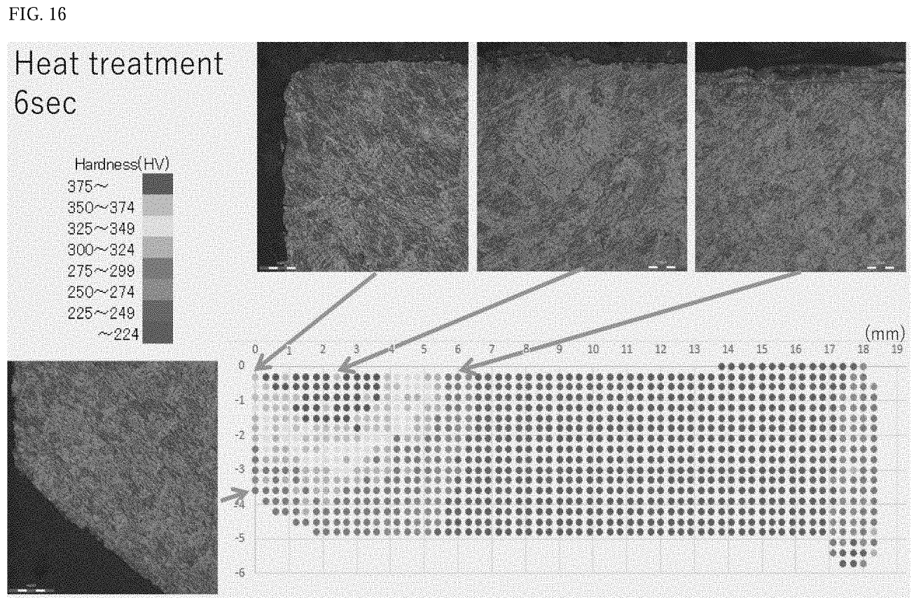

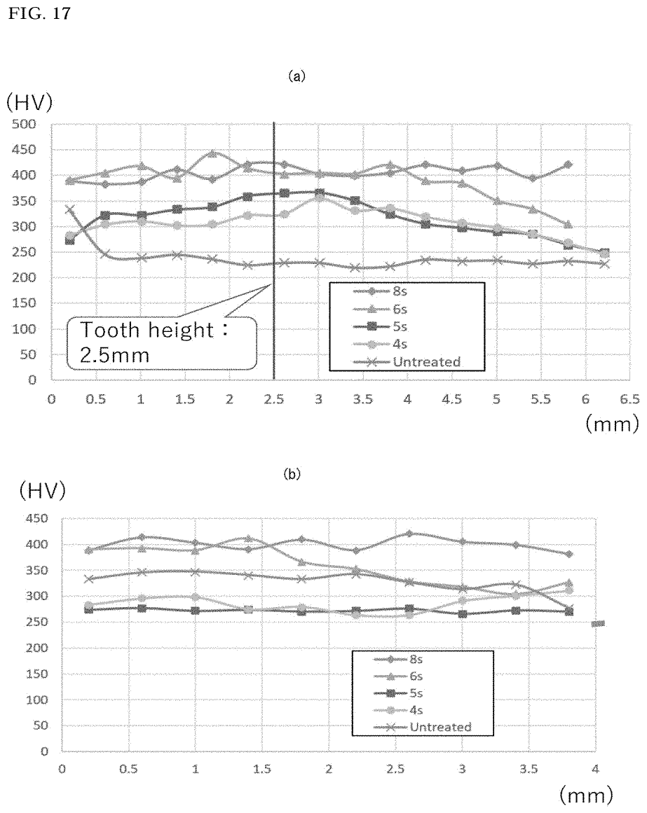

FIG. 11 to FIG. 17 are charts for explaining differences in hardness (Vickers hardness (HV)) and surface structure depending on the presence/absence of the heat treatment. FIG. 11 and FIG. 12 illustrate hardness distributions of the external gear 21 not having undergone the heat treatment (Untreated), FIG. 13 and FIG. 14 illustrate hardness distributions when the heat treatment time is five seconds, and FIG. 15 and FIG. 16 illustrate hardness distributions when the heat treatment time is six seconds. Note that conditions of the heat treatment of the external gear 21 used in the measurement in FIG. 13 and FIG. 14 and the heat treatment of the external gear 21 used in the measurement in FIG. 15 and FIG. 16 are the same except for the heat treatment time. Further, the graphs in FIGS. 17(a), (b) summarize the hardness distributions in the absence of the heat treatment (Untreated) and the hardness distributions when the heat treatment time is four seconds, five seconds, six seconds, and eight seconds. FIG. 17(a) illustrates the hardness distributions in the radial direction and FIG. 17(b) illustrates the hardness distributions in the thickness direction.

FIG. 11(a), FIG. 13(a), and FIG. 15(a) each illustrate the hardness distribution in a section along the radial direction of the external gear 21, where the calibrations on the horizontal axis indicate distance along the radial direction of the external teeth 21 from a top land of the external teeth 212, and the calibrations on the vertical axis indicate distance along the thickness direction of the external teeth 21 from one end surface in terms of the tooth width direction of the external teeth 212. FIG. 11(b), FIG. 13(b), and FIG. 15(b) each illustrate the hardness distribution in the one end surface in terms of the tooth width direction, and FIG. 11(c), FIG. 13(c), and FIG. 15(c) are enlarged charts of FIG. 11(b), FIG. 13(b), and FIG. 15(b). Note that the three-digit numerical values written in FIGS. 11(a), (c), FIGS. 13(a), (c), and FIGS. 15(a), (c) are each the hardness (Vickers hardness (HV)).

As illustrated in FIG. 11, in the absence of the heat treatment (Untreated), the hardness was slightly high in the vicinity of the tooth tips and at a position close to the axial center owing to work hardening at the time of the punching, but was 224 HV or less in almost the entire range in the radial direction, and the hardness of the surfaces of the external teeth 212 was 250 to 274 HV even at their positions where the hardness was highest. In the case where the heat treatment time is five seconds in FIG. 13, it is seen that the hardness of the external teeth 212 is 250 to 274 HV at their tooth tips but as they go closer to the axial center, the hardness is 300 to 324 HV, 325 to 349 HV, and 350 to 374 HV and thus gradually increases (see FIG. 13(c)). The surfaces of the vicinity of tooth bases have a very high hardness of 375 HV or more. Therefore, in the case of FIG. 13 where the heat treatment time is five seconds, the external teeth 212 are very hard at the tooth bases while the hardness gradually decreases as they go toward the tooth tips. That is, the tooth bases of the external teeth 212 are firmly supported with high strength while the vicinities of the tooth tips have a structure not likely to crack or fracture. On the other hand, in the case of FIG. 15 where the heat treatment time was six seconds, the external teeth 212 had a high hardness of about 375 HV or more from the tooth tips to the tooth bases, but were inferior in toughness to those in the case of FIG. 13 where the heat treatment time was five seconds.

FIG. 12, FIG. 14, and FIG. 16 are photographs of surface structures corresponding to FIG. 11(a), FIG. 13(a), and FIG. 15(a). As illustrated in FIG. 12, in the absence of the heat treatment, almost all the parts have a ferrite structure. In the case where the heat treatment time is six seconds, almost all the regions of the external teeth 212 have a martensite structure as illustrated in FIG. 16, but in the case where the heat treatment time is five seconds, the external teeth 212 have some regions having a martensite structure and some regions having a ferrite structure, and the particle size of the martensite structure is small as illustrated in FIG. 14, which shows that the five-second heat treatment achieves a better balance between hardness and toughness. Therefore, the heat treatment by the induction heating can also bring about a sufficient effect in a relatively short time.

In the above-described embodiment, the internal gear 31 is formed through the punching of the plate, but can be formed using a pipe member as its material. In the punching of the plate, the part on the inner side of the inner circumferential surface 313 of the internal gear 31 becomes a waste material, but the shaping of the pipe member can reduce such a waste material, leading to a yield improvement.

### EXPLANATION OF REFERENCE SIGNS

10 reclining device
20 one gear part
21 external gear
211 outer circumferential surface
212 external teeth
213 inner circumferential surface
22 external gear bracket
221 cylinder portion
222 flange portion
30 other gear part
31 internal gear
311 outer circumferential surface
312 internal teeth
313 inner circumferential surface
32 internal gear bracket
321 bottom wall
322 outer circumferential wall
323 inner circumferential wall
40 rotation control part
41, 42 wedge-shaped member
43 spring
44 rotation operation member

1. A reclining device comprising:
one gear part connected to one of a seat cushion and a seat back; and the other gear part connected to the other of the seat cushion and the seat back,
wherein the one gear part includes an external gear,
wherein the other gear part includes an internal gear which has internal teeth engaged with external teeth of the external gear and larger in number than the external teeth, and
wherein axial centers of the external gear and the internal gear are set eccentric from each other,
the reclining device comprising a rotation control part which controls relative rotation of the external gear and the internal gear,
wherein the external gear and the internal gear are ring-shaped gears, and the external teeth and the internal teeth each have a tooth width substantially corresponding to a thickness of an outer circumferential surface of the external gear or an inner circumferential surface of the internal gear.

2. The reclining device according to claim 1,
wherein the one gear part includes an external gear bracket higher in strength than the external gear and having a cylinder portion fixed to an inner circumferential surface of the external gear and a flange portion projecting outward from one end of the cylinder portion, and
wherein the cylinder portion is fixed to the inner circumferential surface of the external gear by welding.

3. The reclining device according to claim 2, wherein the cylinder portion and the inner circumferential surface of the external gear are welded all along a circumferential direction which is along a boundary between the cylinder portion and the inner circumferential surface, by laser light radiated in an axial direction.

4. The reclining device according to claim 2, wherein the flange portion of the external gear bracket has a size large enough to extend off an edge of an end surface of the external gear and cover at least part of an end surface of the internal gear.

5. The reclining device according to claim 2,
wherein the other gear part includes an internal gear bracket higher in strength than the internal gear and having a bottom wall having a through hole at a center and an outer circumferential wall rising from an outer circumferential edge of the bottom wall and fixed to an outer circumferential surface of the internal gear, and
wherein the outer circumferential wall is fixed to the outer circumferential surface of the internal gear by welding.

6. The reclining device according to claim 5, wherein the outer circumferential wall and the outer circumferential surface of the internal gear are welded all along the circumferential direction which is along a boundary between the outer circumferential wall and the outer circumferential surface, by laser light radiated in the axial direction.

7. The reclining device according to claim 5, wherein the internal gear bracket has an inner circumferential wall which rises from an inner circumferential edge of the bottom wall in a direction in which the outer circumferential wall rises, the inner circumferential wall being smaller in inside diameter than the cylinder portion of the external gear bracket.

8. The reclining device according to claim 1, wherein the external teeth of the external gear and the internal teeth of the internal gear are heat-treated.

9. A seat comprising:
a seat cushion and a seat back, the seat comprising the reclining device according to claim 1.

10. A production method for a reclining device,
the reclining device including: one gear part connected to one of a seat cushion and a seat back; and the other gear part connected to the other of the seat cushion and the seat back,
wherein the one gear part includes an external gear,
wherein the other gear part includes an internal gear which has internal teeth engaged with external teeth of the external gear and larger in number than the external teeth, and
wherein axial centers of the external gear and the internal gear are set eccentric from each other,
the reclining device including a rotation control part which controls relative rotation of the external gear and the internal gear, and the production method comprising:
forming, by punching, the external gear and the internal gear in a ring shape, with the external teeth and the internal teeth each having a tooth width substantially corresponding to a thickness of an outer circumferential surface of the external gear or an inner circumferential surface of the internal gear;
using an external gear bracket higher in strength than the external gear and having a cylinder portion and a flange portion projecting outward from the cylinder portion, and fixing an inner circumferential surface of the external gear to the cylinder portion by welding while aligning the axial center of the external gear with an axial center of the external gear bracket; and
using an internal gear bracket higher in strength than the internal gear and having a bottom wall having a through hole at a center and an outer circumferential wall rising from an outer circumferential edge of the bottom wall to be fixed to an outer circumferential surface of the internal gear, and fixing the outer circumferential surface of the internal gear to the outer circumferential wall by welding while aligning the axial center of the internal gear with an axial center of the internal gear bracket.

11. The production method for the reclining device according to claim 10,
the production method comprising:
radiating laser light in an axial direction to weld the cylinder portion and the inner circumferential surface of the external gear all along a circumferential direction which is along a boundary between the cylinder portion and the inner circumferential surface; and
radiating laser light in the axial direction to weld the outer circumferential wall and the outer circumferential surface of the internal gear all along the circumferential direction which is along a boundary between the outer circumferential wall and the outer circumferential surface.

12. A connection method for connecting a reclining device to a cushion bracket attached to a seat cushion frame, the connection method comprising:
using, as the cushion bracket, one having a ring-shaped projection projecting outward;
disposing the reclining device produced by the production method for the reclining device according to claim 9 with an axial-direction inner end surface of the external gear stacked on the ring-shaped projection; and
welding the axial-direction inner end surface of the external gear to the ring-shaped projection all along a circumferential direction of the ring-shaped projection, disposing the cylinder portion of the external gear bracket adjacently to a stepped portion of the ring-shaped projection, and performing welding on a boundary between the stepped portion and the cylinder portion all along the circumferential direction of the ring-shaped projection.
